(19) United States
(12) Patent Application Publication
(10) Pub. No.: US 2004/0231208 A1
(43) Pub. Date: Nov. 25, 2004

(54) Method and apparatus for displaying advertisements on a vehicle

(76) Inventor: John Dunlop Pitt, Glasgow (GB)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/479,138

(22) PCT Filed: Jun. 14, 2002
(86) PCT No.: PCT/GB02/02748

(30) Foreign Application Priority Data
Jun. 23, 2001 (GB) 0115449.1

(51) Int. Cl. G09F 21/04

(52) U.S. Cl. 40/590

(57) ABSTRACT

An advertising panel which can be used to selectively attach advertisements to the sides of road vehicles in a readily demountable manner includes a sheet of plastic mesh material and fasteners, the sheet having an image applied to a first side of the sheet. The fasteners are reclosable interlocking fasteners adapted to engage with corresponding interlocking fasteners provided on the vehicle. The corresponding fasteners may be provided on a rigid wall or a vehicle curtain. The mesh allows air to pass through the panel so that the panel remains securely mounted without flapping in transit. The system requires minimal structural alterations to a vehicle to enable it to carry advertising panels, and allows advertising panels to be changed easily.

This invention relates to mobile advertisements, and relates more particularly but not exclusively to a system for selectively attaching advertisements to the sides of road vehicles in a readily demountable manner, and to a method of adapting road vehicles for the selective display of advertisements.

Currently there are many load-carrying road vehicles having substantially vertical sides which are either plain, or carry minimal information (e.g. merely the name of a transport company). These vehicle sides are extensively exposed to the sight of the general public, not least because the majority of journeys of load-carrying road vehicles take place on public roads that are also extensively used by pedestrians and/or users of personal road transport and/or passengers in public road transport. Consequently, the sides of load-carrying road vehicles represent a facility for mobile advertising that currently tends to be used only by the vehicle owners for self-advertisement. Some use of the exteriors of road vehicles is known for advertising by organisations other than the vehicle owner, but such advertising is currently limited to public transport vehicles that carry human passengers rather than inanimate cargoes, and the advertisements are either pasted-on paper, or in the nature of bodywork painting that is substantially permanent and not changeable without time-consuming repainting of the vehicle.

U.S. Pat. No. 5,845,423 and U.S. Pat. No. 5,657,566 address the problem of providing advertisements on the sides of load-carrying road vehicles, but the effectiveness of their solutions is hampered by the fact that the vehicles need extensive structural modification in the form of added rails, mounting brackets and fasteners and the like, to allow the mounting and removal of advertisement panels. Moreover the advertisement panels themselves are complicated and relatively expensive. Moreover the advertisement panels can be used only with rigid sided vehicles, since they do not allow simple access to the side curtains of flexible sided vehicles, which provide access to the load area by allowing the removal or rolling up of flexible side curtains attached to the frame of the vehicle.

It is an object of the present invention to provide a system and a method for enabling mobile advertisements to be selectively mounted on load-carrying road vehicles in a manner which is simple to carry out and which is cost effective, allowing the use of economical advertisement panels and the requiring minimal structural alterations to a vehicle to enable it to carry advertisement panels. It is a further object of the invention to provide a system and a method for enabling mobile advertisements to be selectively mounted on both rigid sided and flexible sided road vehicles.

As used in this specification, the term “vehicle” refers to a road vehicle possessing substantially vertical sides suitable for carrying advertisements, such sides including but not being restricted to permanently fixed sides, sides formed as one or more panels that are demountable or hinged for providing access to a cargo carried by the vehicle, and curtain sides (i.e. curtains of more or less flexible sheet material whose upper edges are suspended from the vehicle, and whose lower edges are clipped or strapped to the vehicle).

As used in this specification, the term “advertisement” refers to at least one essentially two-dimensional image having an impression on a spectator that is primarily or wholly visual.

According to a first aspect of the present invention there is provided an advertising panel for external mounting on a vehicle, the panel comprising a sheet of plastic mesh material and fasteners, the sheet having an image applied to a first side of the sheet.

Preferably the fasteners comprise reclosable interlocking fasteners adapted to engage with corresponding interlocking fasteners provided on the vehicle. Preferably the fasteners are 3M™ Dual Lock™ fasteners. Alternatively the fasteners may be hook and loop fasteners or similar.

Preferably the sheet is flexible and woven. Preferably the sheet is of PVC, polyester or a combination thereof. However, other suitable plastic materials may be used singly or in combination, provided they have suitable strength or printability properties.

Preferably the mesh is provided with apertures allowing air passage therethrough. Preferably the sheet has an air permeability of at least 1000 litres per second at 100 pascal.

Preferably the panel is provided with a solid reinforcing strip along at least one edge of the sheet. Preferably the solid reinforcing strip is provided on the leading edge of the sheet, the leading edge being the edge nearest the front of the vehicle when the panel is mounted on a vehicle. Preferably the leading edge of the sheet is provided with a fastener which extends over the entire length of the leading edge.

A reinforcing strip may be provided on all the edges of the sheet. Fasteners may be provided at spaced intervals along all the edges of the sheet.

According to a second aspect of the present invention there is provided a vehicle, the vehicle having a side wall provided with reclosable fasteners on the exterior surface thereof, the vehicle having an advertising panel mounted on said side wall, the panel comprising a sheet of plastic mesh material and reclosable fasteners releasably attachable to the fasteners provided on the side wall, the sheet having an image applied to a first side of the sheet.

Preferably the advertising panel is a panel according to the first aspect of the present invention.

Preferably the reclosable fasteners provided on the side wall are bonded to the side wall by adhesive. Alternatively they may be secured to the side wall by fixing means such as bolts, screw, rivets or similar.

According to a third aspect of the present invention there is provided a vehicle, the vehicle having a load bearing volume at least partially enclosed by a curtain, said curtain being provided with reclosable fasteners on its surface, the vehicle having an advertising panel mounted on said curtain, the panel comprising a sheet of plastic mesh material and reclosable fasteners releasably attachable to the fasteners provided on the curtain, the sheet having an image applied to a first side of the sheet.

Preferably the advertising panel is a panel according to the first aspect of the present invention.

Preferably the reclosable fasteners provided on the curtain are bonded to the curtain by adhesive. Alternatively they may be secured to the curtain by fixing means such as bolts, screw, rivets, staples or similar. Alternatively they may be secured to the curtain by thermal bonding, ultrasonic bonding, stitching, moulding or similar.

According to a fourth aspect of the present invention there is provided a method of modifying a vehicle to display at least one advertising panel on at least one side of the vehicle, said method comprising the steps of:

securing reclosable fasteners in a predetermined pattern on the side of the vehicle or on a curtain adapted to be mounted on the side of the vehicle, and

releasably attaching an advertising panel to the reclosable fasteners, the panel comprising a sheet of plastic mesh material having an image applied to a first side of the sheet and reclosable fasteners provided in a pattern corresponding to the predetermined pattern of the reclosable fasteners on the side of the vehicle or on the curtain adapted to be mounted on the side of the vehicle.

Preferably the method includes the further steps of:

removing the advertising panel by separating the reclosable fasteners provided on the advertising panel from the reclosable fasteners provided on the side of the vehicle or on the curtain adapted to be mounted on the side of the vehicle, and

releasably attaching a second advertising panel to the reclosable fasteners, the second panel comprising a sheet of plastic mesh material having an image applied to a first side of the sheet and reclosable fasteners provided in a pattern corresponding to the predetermined pattern of the reclosable fasteners on the side of the vehicle or on the curtain adapted to be mounted on the side of the vehicle.

Preferably the or each advertising panel is a panel according to the first aspect of the present invention.

According to a fifth aspect of the present invention there is provided a business method for procuring and exploiting mobile advertisements, said business method comprising the steps of:

agreeing with the owner (or with the agent or representative of the owner) of a vehicle to the modification and use of at least one vehicle owned by said owner for the mounting and display of advertisements in return for the payment of money or moneys worth to the owner (or to the agent or representative of the owner),

modifying said at least one vehicle by the securing of reclosable fasteners in a predetermined pattern on the side of the vehicle or on a curtain adapted to be mounted on the side of the vehicle,

vending use of the vehicle for the mounting and display of at least one advertisement in return for money or moneys worth, and

attaching at least one advertisement to said reclosable fasteners in a manner that permits the advertisement to cover at least part of one side of the vehicle to be visible to at least one spectator.

Preferably the advertisement is provided in the form of an advertising panel according to the first aspect of the invention.

Embodiments of the invention will now be described by way of example only, with reference to the drawings in which:

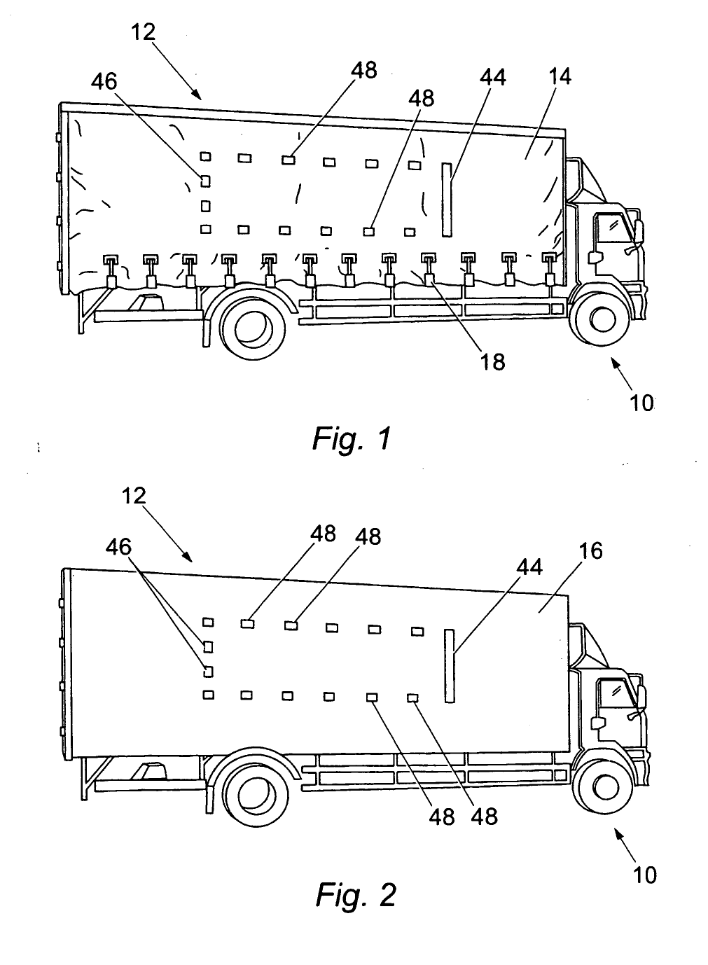

FIG. 1 shows a curtain-sided lorry provided with fasteners to allow attachment of an advertising panel according to the invention;

FIG. 2 shows a rigid-sided lorry provided with fasteners to allow attachment of an advertising panel according to the invention;

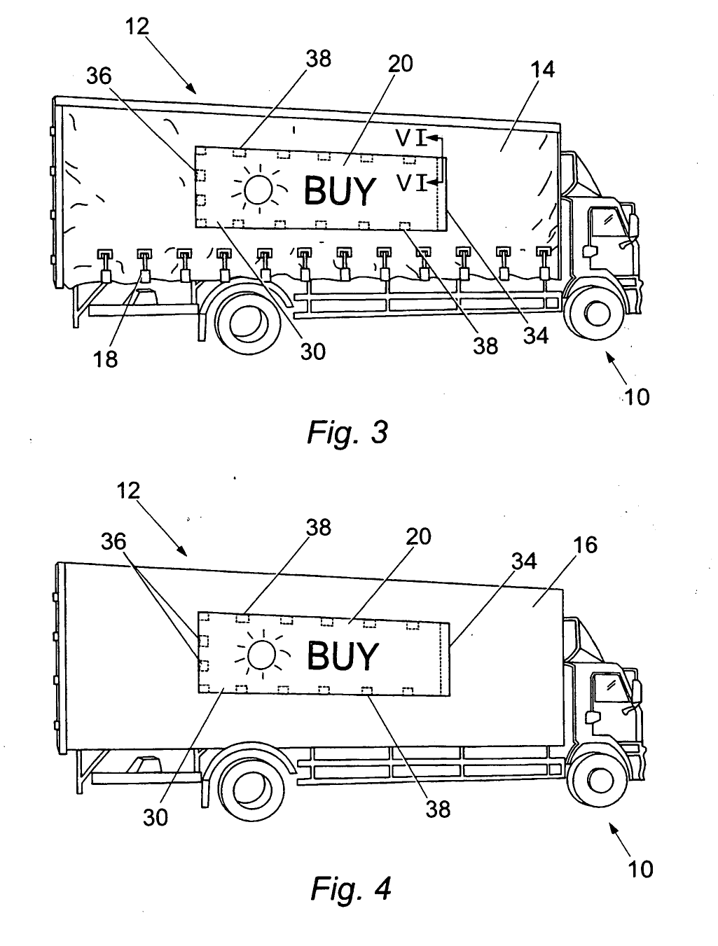

FIG. 3 shows the lorry of FIG. 1 with an advertising panel attached;

FIG. 4 shows the lorry of FIG. 2 with an advertising panel attached;

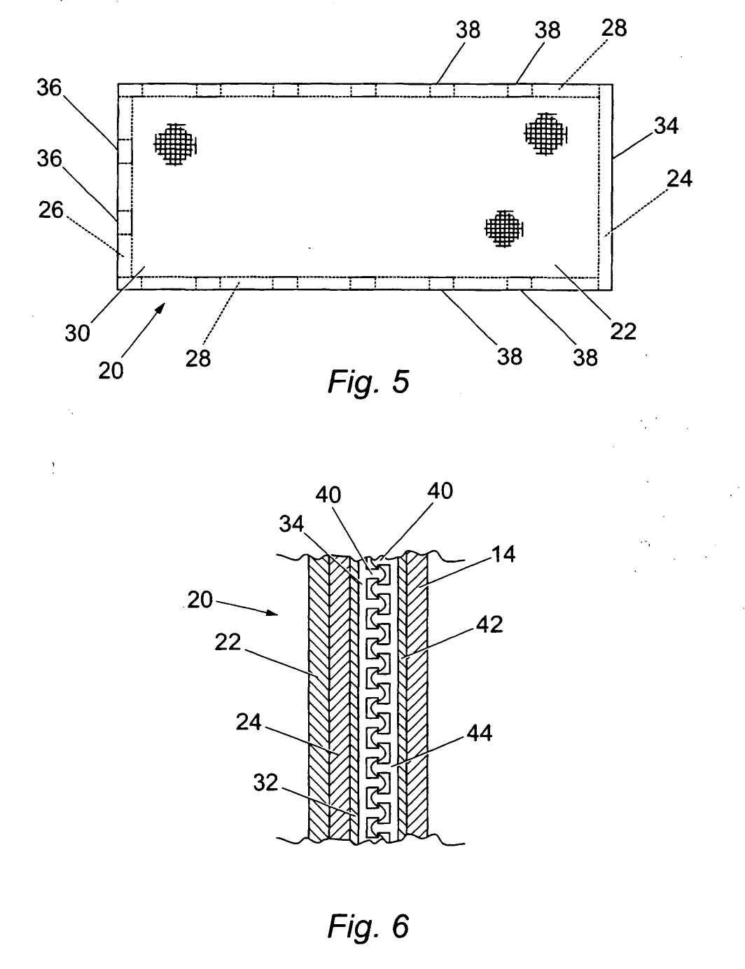

FIG. 5 shows an advertising panel according to the invention; and

FIG. 6 is a partial section on line VI-VI in FIG. 3.

FIG. 1 shows a lorry 10 having a load area 12 which is covered on each longitudinal side by a curtain 14. The curtain 14 is secured to the vehicle at its upper edge and is tensioned in a conventional manner by means of tensioning straps 18 which connect the lower edge of the curtain to the vehicle. The curtain 14 and straps 18 are well known in the art and may be of any suitable flexible material. Typically the curtain 14 is of reinforced PVC while the straps 18 are of nylon webbing.

The surface of the curtain 18 has a number of fasteners 44, 46, 48 bonded to it by means of adhesive 42, although it is to be understood that other suitable means of securing the fasteners to the curtain may be used, including fixing means such as bolts, screw, rivets, staples or similar. Alternatively the fasteners may be secured to the curtain by thermal bonding, ultrasonic bonding, stitching, moulding or similar. The fasteners 44, 46, 48 are components of a reclosable fastener product such as 3M™ Dual Lock™ fastener. The fasteners 44, 46, 48 are selected and positioned to engage with corresponding fasteners 34, 36, 38 provided on an advertising panel 20, as shown in FIG. 5.

FIG. 2 shows a lorry 10 having a load area 12 which is covered on each longitudinal side by a rigid wall 16. The arrangement of fasteners 44, 46, 48 on the rigid wall 16 is the same as that described above with respect to the curtain 14 of FIG. 1. The surface of the wall 16 has a number of fasteners 44, 46, 48 bonded to it by means of adhesive 42, although it is to be understood that other suitable means of securing the fasteners to the wall may be used, including fixing means such as bolts, screw, rivets, staples or similar.

FIG. 3 shows the curtain sided lorry 10 of FIG. 1 with an advertising panel 20 fixed to the curtain 14 using the fasteners 44, 46, 48 on the curtain and the fasteners 34, 36, 38 on the advertising panel 20. The panel 20 is aligned with the fasteners 44, 46, 48 on the curtain and then pressed into place. An audible snap informs the operator that the fasteners are engaged.

FIG. 4 shows the rigid sided lorry 10 of FIG. 2 with an advertising panel 20 fixed to the wall .16 in the manner described above with reference to FIG. 3.

To remove the panel 20 from the vehicle 10 it is necessary to separate the fasteners 38, 48 at the lower rear corner 30 of the panel 20 by pulling at a free edge portion of the panel 20 adjacent to the corner 30. A tag (not shown) may be provided at the corner 30 to facilitate the separation of the fasteners 38, 48, but this is not essential. If a tag is provided, a locking means such as a small hasp and padlock may also be provided to lock the tag and prevent unauthorised removal of the panel 20 from the vehicle 10. The remaining fasteners can then be readily separated by a peeling action, since the panel 20 is of flexible sheet material.

The construction of the advertising panel 20 will now be described with reference to FIGS. 5 and 6. The panel comprises a sheet 22 of plastic mesh material. Typically the mesh material comprises a woven polyester base fabric coated with PVC. The base fabric may have between 3 and 10 (preferably 5) threads per cm in both warp and weft directions. Flexible plasticised PVC is applied to both sides to produce a material having a weight of between 100 and 800 g/m², preferably between about 200 and 550 g/m², such that the warp and weft fibres are bonded to each other at their intersections.

The apertures in the mesh allow an air permeability of between 1000 and 6000 litres/second at 100 pascal, preferably about 2800 litres/second. A suitable mesh is that sold by VUFLEX Digital under the name VUFLEX Digital 550, although it is to be understood that any suitable plastic mesh may be used. The air permeability ensures that the panel remains flat against the supporting surface, whether it be a solid wall of a vehicle or a curtain. Air pressure either side of the panel is equalised, thereby preventing flapping of the panel against the supporting surface.

The mesh must be capable of being printed on, to provide an advertising image on one side. Any suitable printing process may be used, such as laser printing or screen printing. The apertures must be small enough such that the effect of the advertising panel when mounted on a solid surface and viewed from a distance is of an opaque panel. In a particular embodiment the plasticised warp and weft fibres have a width of about 1 mm, while the apertures are about 1 mm square. An opaque effect is produced if the apertures make up about 25% or less of the area of the panel. If the apertures make up more than about 35% of the area of the panel the opacity effect is diminished.

Reinforcing strips 24, 26, 28 of reinforced PVC or similar material are bonded to the edges of the mesh sheet 22 to prevent the advertising panel 20 from tearing or stretching in use. The reinforcing strips may be bonded by adhesive or by ultrasonic welding. The strips may be of polyester scrim coated with PVC for easy joining to the mesh sheet 22. The thickness of the strips is chosen so that the sheet 22 can be subject to the chosen printing process even with the strips 24, 26, 28 attached. Typically the reinforcing strips 24, 26, 28 are between 5 and 15 cm wide, and extend to the perimeter of the sheet 22.

Fasteners 34, 36, 38 are bonded to the reinforcing strips 24, 26, 28 by means of adhesive 32, although it is to be understood that other suitable means of securing the fasteners to the strips may be used, including thermal bonding, ultrasonic bonding, stitching, moulding or similar. The fasteners 34, 36, 38 are components of a reclosable fastener product such as 3M™ Dual Lock™ fastener, which is provided with a contact adhesive on its rear face and a peel-off backing sheet. The fasteners 34, 36, 38 are positioned to engage with the corresponding fasteners 44, 46, 48 provided on the vehicle, by means of the interlocking action of the mushroom-shaped stems of the corresponding fasteners.

It has been found that it is advantageous to provide a continuous fastener 34 extending all the way along the leading edge of the advertising panel 20, bonded to the reinforcing strip 24. The leading edge is that edge which is nearer the front of the vehicle in use. The use of a continuous fastener 34 engaging with a corresponding continuous fastener 44 on the vehicle 10 prevents the leading edge of the panel 20 lifting away from the vehicle at any point, and helps to hold the panel 20 to the wall 16 or curtain 14 without flapping.

It has further been found that it is not necessary to provide continuous fasteners on the other edges of the advertising panel 20. In fact the preferred solution is to provide discrete fasteners 36, 38 of length between 3 and 10 cm, preferably about 4 to 5 cm, and of width between 3 and 10 cm, preferably about 4 to 5 cm, at spacings of between 20 and 80 cm, preferably about 30 cm, along the remaining vertical reinforcing strip 26 and the upper and lower reinforcing strips 28. The perforations in the mesh sheet 22 permit equalisation of pressure on both sides of the mesh sheet 22 when the vehicle 10 travels at speed, so there is no differential air pressure causing bellowing or flapping of the advertising panel. The spaced fasteners 36, 38 engage with corresponding spaced fasteners 46, 48 on the vehicle 10 and serve to hold the advertising panel 20 flat against the wall 16 or curtain 14 of the vehicle 10.

Particular arrangements of fasteners are provided for particular models of vehicles 10 and their corresponding adverting panels 20. For example a Transit® van might carry a particular size of advertising panel 20; panels for these vans would carry a particular pattern of fasteners. Corresponding fasteners on Transit® vans would be fixed to the side wall 16 of the van in a corresponding pattern using a particular Transit® stencil. Similarly, a particular make of Trailer might carry a particular larger size of advertising panel 20; panels for these trailers would carry a different particular pattern of fasteners. Corresponding fasteners on the trailers would be fixed to the curtain 14 or side wall 16 of the trailer in a corresponding pattern using a particular trailer stencil.

It is to be understood that other fasteners may be used instead of 3M™ Dual Lock™ fasteners, for example hook and loop or Velcro™ fasteners, or any other fasteners which permit multiple use and re-use and which provide sufficient strength to withstand aerodynamic shear forces generated on the advertising panel when the vehicle is travelling at high speed.

In practice left handed and right handed advertisement panels 20 will be produced, each having the continuous fastener 34 on the left or right hand edges respectively, for mounting on opposite sides of a vehicle, since the leading edge of the panel will be on the right hand side of the panel 20 when the panel is mounted on the curtain 14 visible in FIG. 1, while the leading edge of the panel will be on the left hand side of the panel 20 when the panel is mounted on the opposite curtain on the side of the vehicle not visible in FIG. 1.

An example of a business method which makes use of the advertising panels of the invention will now be described. A load-carrying road vehicle in the form of a lorry 10 with a roof and curtain sides 14 is made the subject of a contractual agreement between an advertising agency and the vehicle owner for the purpose of modifying and utilising the vehicle for mobile advertising, in return for agreed payment by the advertising agency to the vehicle owner. Upon conclusion of the agreement, the vehicle is modified by the attachment of fasteners 44, 46, 48 in a predetermined pattern on each curtain. Advertisements are commissioned by clients of the advertising agency, and prepared in the form of advertising panels 20 as described above. Suitable sizes are heights slightly less than the height of the curtain sides, and lengths either the length of the trailer, or some large fraction thereof such as half or quarter of the vehicle length. Particular makes and models of vehicles and trailers may have associated preferred sizes of advertising panels. Vehicles having sliding doors in their sides might have advertising panels provided in two parts, one part attached to the rigid wall and one part attached to the sliding door.

The advertisements are commissioned for a particular period of time, for example 8 weeks. At the beginning of the period the advertising agency affixes advertising panels to one or both sides of the vehicle on which the advertisement is to be displayed. During the 8 week period the vehicle is driven along public roads while in commercial use delivering cargo, the advertisements being on display to spectators throughout the time that the vehicle remains on public roads.

When cargo is delivered, the straps 18 can be released and the curtain 14 rolled up to allow access to the cargo while the flexible advertising panel 20 remains secured to the curtain 14.

At the expiry of the 8 week period, the advertising panel 20 can be replaced by a new advertising panel which is the subject of a separate commission agreement between the advertising agency and one of its clients. The actual physical replacement of the advertisements requires only a few minutes of direct access to the vehicle sides, e.g. at the vehicle depot or at a refuelling stop, where the previous advertisements are demounted by peeling action and the new advertisements are mounted in place.

Modifications and variations of the above-described embodiments can be adopted without departing from the scope of the invention.

1. An advertising panel for external mounting on a vehicle, the panel comprising a sheet of woven plastic mesh material and fasteners, the sheet having an image applied to a first side of the sheet.

2. An advertising panel according to claim 1, wherein the fasteners comprise reclosable interlocking fasteners adapted to engage with corresponding interlocking fasteners provided on the vehicle.

3. An advertising panel according to claim 2, wherein the fasteners are 3M™ Dual Lock™ fasteners.

4. An advertising panel according to any preceding claim, wherein the sheet is flexible.

5. An advertising panel according to any preceding claim, wherein the sheet is of PVC, polyester or a combination thereof.

6. An advertising panel according to any preceding claim, wherein the mesh is provided with apertures allowing air passage therethrough, such that the sheet has an air permeability of at least 1000 litres per second at 100 pascal.

7. An advertising panel according to any preceding claim, wherein the panel is provided with a reinforcing strip along at least one edge of the sheet.

8. An advertising panel according to claim 7, wherein the reinforcing strip is provided on the leading edge of the sheet, the leading edge being the edge nearest the front of the vehicle when the panel is mounted on a vehicle.

9. An advertising panel according to claim 8, wherein the leading edge of the sheet is provided with a fastener which extends over the entire length of the leading edge.

10. An advertising panel according to claim 7, wherein a reinforcing strip is provided on all the edges of the sheet.

11. An advertising panel according to claim 10, wherein fasteners are provided at spaced intervals along all the edges of the sheet.

12. A vehicle having at least one side wall provided with reclosable fasteners on the exterior surface thereof, the vehicle having an advertising panel mounted on said side wall, the panel comprising a sheet of plastic mesh material and reclosable fasteners releasably attachable to the fasteners provided on the side wall, the sheet having an image applied to a first side of the sheet.

13. A vehicle according to claim 12, wherein the advertising panel is an advertising panel according to any one of claims 1 to 11.

14. A vehicle according to claim 12 or 13, wherein the reclosable fasteners provided on the side wall are bonded to the side wall by adhesive.

15. A vehicle according to claim 12 or 13, wherein the reclosable fasteners provided on the side wall are secured to the side wall by fixing means.

16. A vehicle having a load bearing volume at least partially enclosed by a curtain, said curtain being provided with reclosable fasteners on its surface, the vehicle having an advertising panel mounted on said curtain, the panel comprising a sheet of plastic mesh material and reclosable fasteners releasably attachable to the fasteners provided on the curtain, the sheet having an image applied to a first side of the sheet.

17. A vehicle according to claim 16, wherein the advertising panel is an advertising panel according to any one of claims 1 to 11.

18. A vehicle according to claim 16 or 17, wherein the reclosable fasteners provided on the curtain are bonded to the curtain by adhesive.

19. A vehicle according to claim 16 or 17, wherein the reclosable fasteners provided on the curtain are secured to the curtain by fixing means.

20. A vehicle according to claim 16 or 17, wherein the reclosable fasteners provided on the curtain are secured to the curtain by a securing means selected from thermal bonding, ultrasonic bonding, stitching and moulding.

21. A method of modifying a vehicle to display at least one advertising panel on at least one wall of the vehicle, said method comprising the steps of:
securing reclosable fasteners in a predetermined pattern on the wall of the vehicle, and
releasably attaching an advertising panel to the reclosable fasteners, the panel comprising a sheet of plastic mesh material having an image applied to a first side of the sheet and reclosable fasteners provided in a pattern corresponding to the predetermined pattern of the reclosable fasteners on the wall of the vehicle.

22. A method according to claim 21, further including the steps of:
removing the advertising panel by separating the reclosable fasteners provided on the advertising panel from the reclosable fasteners provided on the wall of the vehicle, and
releasably attaching a second advertising panel to the reclosable fasteners, the second panel comprising a sheet of plastic mesh material having an image applied to a first side of the sheet and reclosable fasteners provided in a pattern corresponding to the predetermined pattern of the reclosable fasteners on the wall of the vehicle.

23. A method according to claim 21 or 22, wherein the or each advertising panel is an advertising panel according to any one of claims 1 to 11.

24. A method of modifying a vehicle to display at least one advertising panel on at least one side of the vehicle, said method comprising the steps of:
securing reclosable fasteners in a predetermined pattern on a curtain adapted to be mounted on the side of the vehicle, and
releasably attaching an advertising panel to the reclosable fasteners, the panel comprising a sheet of plastic mesh material having an image applied to a first side of the sheet and reclosable fasteners provided in a pattern corresponding to the predetermined pattern of the reclosable fasteners on the curtain adapted to be mounted on the side of the vehicle.

25. A method according to claim 21, further including the steps of:
removing the advertising panel by separating the reclosable fasteners provided on the advertising panel from the reclosable fasteners provided on the curtain adapted to be mounted on the side of the vehicle, and
releasably attaching a second advertising panel to the reclosable fasteners, the second panel comprising a sheet of plastic mesh material having an image applied to a first side of the sheet and reclosable fasteners provided in a pattern corresponding to the predetermined pattern of the reclosable fasteners on the curtain adapted to be mounted on the side of the vehicle.

26. A method according to claim 24 or 25, wherein the or each advertising panel is an advertising panel according to any one of claims 1 to 11.

27. A method for procuring and exploiting mobile advertisements, said method comprising the steps of:
agreeing with the owner (or with the agent or representative of the owner) of a vehicle to the modification and use of at least one vehicle owned by said owner for the mounting and display of advertisements in return for the payment of money or moneys worth to the owner (or to the agent or representative of the owner),
modifying said at least one vehicle by the securing of reclosable fasteners in a predetermined pattern on the side of the vehicle or on a curtain adapted to be mounted on the side of the vehicle,
vending use of the vehicle for the mounting and display of at least one advertisement in return for money or moneys worth, and
attaching at least one advertisement to said reclosable fasteners in a manner that permits the advertisement to cover at least part of one side of the vehicle to be visible to at least one spectator.

28. A method according to claim 27, in which the advertisement is provided in the form of an advertising panel according to any one of claims 1 to 11.
